(19) United States
(12) Patent Application Publication
(10) Pub. No.: US 2010/0115935 A1
(43) Pub. Date: May 13, 2010

(54) Apparatus for generating energy from tides

(76) Inventor: Albert Piccioni, Summerland (CA)

Correspondence Address: Eric Fincham, 316 Knowlton Road, Lac Brome, QC, J0E 1V0, CA

(21) Appl. No.: 12/590,781

(22) Filed: Nov. 13, 2009

(30) Foreign Application Priority Data
Nov. 13, 2008 (CA) 2,647,993

(51) Int. Cl. F03B 13/26

(52) U.S. Cl. 60/327; 60/398; 290/53

(57) ABSTRACT

An apparatus for generating energy during both rising and falling tides, the apparatus comprising a housing defining an enclosure, at least one opening to the enclosure at a bottom portion thereof, and air passageway having a plenum at either end thereof, each plenum having an opening to the enclosure and an opening to the passageway along with a moveable member to close one of the inlet and outlet such that air will pass through a turbine mounted in the air passageway.

### FIELD OF THE INVENTION

The present invention relates to an apparatus for generating energy from rising and falling tides and also to a method for generating energy.

### BACKGROUND OF THE INVENTION

There are many known devices and methods for generating electrical energy. Many such methods involve the use of fossil fuels. However, this suffers from the disadvantage of the greenhouse gases generated along with other types of pollution. With the expanding requirement for electricity, more environmentally sound ways of generating electricity are desirable.

Recently, there has been a great deal of attention paid to “green” methods of generating electricity including utilizing wind farms and solar power. However, generally these technologies are unable to generate sufficient energy to satisfy the demands for electricity. One other potential source of electrical energy is harnessing the power of waves and tides. It has been estimated that if properly harnessed, tidal energy could generate enough electricity to satisfy the entire world's requirement.

Despite the above, very little has been achieved commercially in generating electricity using tidal power. A known tidal power generation device is shown in U.S. Pat. No. 6,717,284 which has a rack, an air blower mechanism disposed at a predetermined position of the rack, the air blower mechanism comprising an extendable cylinder, a buoy mounted to an end of the extendable cylinder and a tube mounted to another end of the extendable cylinder, the bottom of the buoy being positioned on the sea surface, a power generating mechanism which comprises an air canister and a power generator having a pneumatically operated motor. The air canister is coupled to the tube whereby the tides drive the air blower mechanism to extract energy from the upward movement of the tides. Compressed air is stored in the air canister for subsequent supply to the pneumatically operated motor for driving the power generator.

### SUMMARY OF THE INVENTION

It is an object of the present invention to provide a tidal powered generator device wherein power is obtained both during the rising tide phase and also during the falling tide phase.

According to one aspect of the present invention, there is provided an apparatus for generating energy from rising and falling tides, the apparatus comprising a housing having a top wall and a side wall to thereby define an enclosure, at least one opening to the enclosure located proximate a lower portion of the side wall, at least one air passageway having first and second ends located at an upper end of the enclosure; each of the ends having an inlet to the enclosure and an outlet to the atmosphere, a turbine mounted in the air passageway, a generator operatively associated with the turbine, and a moveable member located at each of the first and second ends to close one of the inlet and the outlet depending on whether the tide is rising or falling.

According to a further aspect of the present invention, there is provided a method of generating electricity from rising and falling tides comprising the steps of mounting an apparatus in a location having a tidal movement, the apparatus having a top wall, and a side wall to thereby define an enclosure, the apparatus also including at least one air passageway having first and second ends, each of the ends having an inlet to the enclosure and an outlet to the atmosphere, a turbine mounted in the air passageway, a generator operatively associated with the turbine, permitting water to enter the enclosure proximate the bottom thereof, passing air displaced from the enclosure to the air passageway to thereby drive the turbine mounted therein, and permitting the air to exit the enclosure, directing air returning to the enclosure during a falling tide through the air passageway in the same direction as during the rising tide.

The present invention provides an apparatus which can generate electricity both from a rising tide and a falling tide.

The apparatus as set forth above, includes a housing the interior of which is herein referred to as an enclosure. The housing may be of any desired configuration and will be described herein as being rectangular. However, any desired configuration for the enclosure may be utilized included spherical, oval, etc.

Located at the top of the housing is an enclosed air passageway which will have one or more turbines mounted therein. The air passageway will have first and second ends with each end being capable of being open either to the enclosure or to the atmosphere. A moveable member can block either the of the openings.

The apparatus may include a plurality of air passageways if so desired. These passageways could be connected either in series or parallel according to the particular design required.

Located at the bottom of the enclosure is one or more openings permitting access for the water to the enclosure. Thus, during a rising tide, water will enter the enclosure forcing the air through the air passageway to drive the turbines. During a falling tide, the moveable members are reversed and air will enter the air passageway in the same direction as during the rising tide. This will in turn drive the turbines to permit generation of electricity.

The enclosure is preferably formed of a concrete material and could be constructed on land and moved, (floated) with the lower openings closed to the desired location. The members covering the lower openings would then be removed and the housing permitted to sink to the bottom.

### BRIEF DESCRIPTION OF THE DRAWINGS

Having thus generally described the invention, reference will be made to the drawings illustrating an embodiment thereof, in which:

FIG. 1 is an end view of an apparatus according to one embodiment of the present invention;

FIG. 2 is a side elevational view thereof;

FIG. 3 is a top plan view thereof;

FIG. 4 is a detailed view of the openings located at the bottom of the apparatus;

FIG. 5 is a detailed view illustrating the arrangement of the air passage way and turbine assembly; and

FIGS. 6a and 6b illustrate the flow of air during a rising tide and a falling tide respectively.

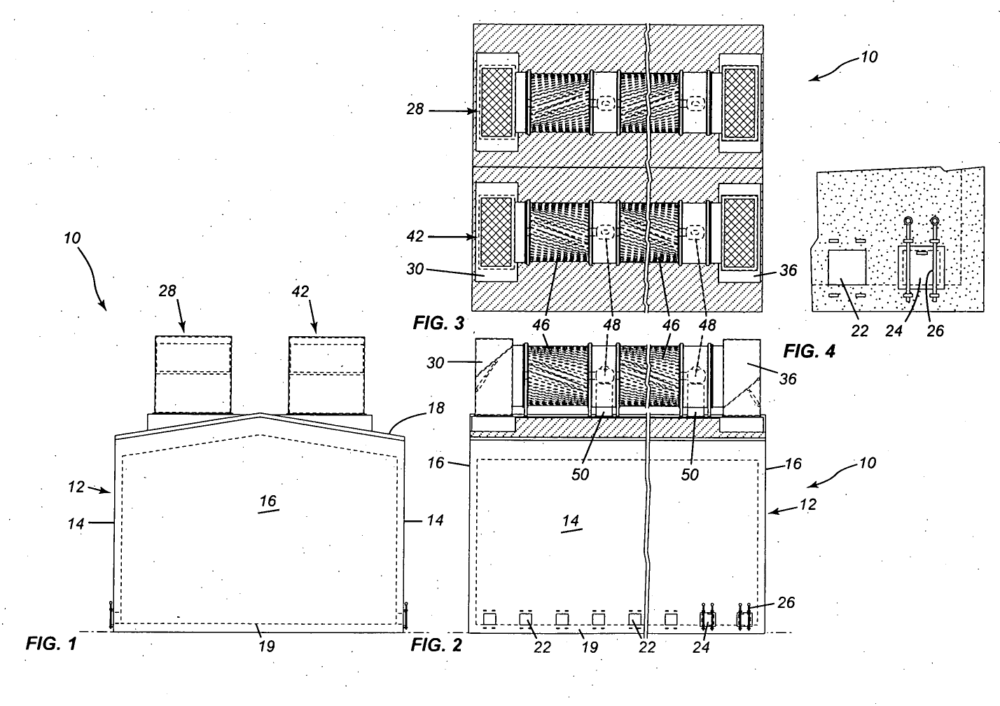

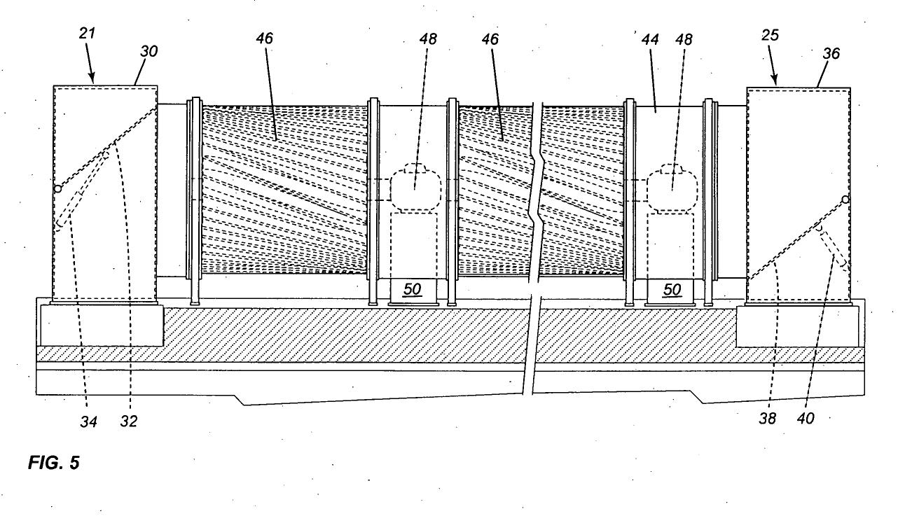

### DETAILED DESCRIPTION OF THE INVENTION

Referring to the drawings in greater detail and by reference characters thereto, there is illustrated an apparatus according to one embodiment of the present invention and which apparatus is generally designated by reference numeral 10.

Apparatus 10 includes a housing generally designated by reference numeral 12 and which is formed, in the illustrated embodiment, of a pair of side walls 14 and a pair of end walls 16 with a top wall 18. There is also a bottom wall 19 although it will be understood that the same is not required for operation of the apparatus.

Walls 14, 16, 18, 19 define an interior enclosure.

There are provided a plurality of openings 22 along side walls 14 to permit the entry and exit of water to the enclosure. Naturally, the number of openings and size thereof can vary depending upon the size of the enclosure. Doors 24 and retaining members 26 associated therewith may be utilized for sealing off openings 22 when desired such as if the apparatus were being towed to its location.

Located on the top are a first turbine assembly 28 and a second turbine assembly 42. Turbine assemblies 28 and 42 may be operated in series or parallel as desired. As both turbine assemblies 28, 42 are substantially identical, only one will be described herein.

First turbine assembly 28 includes a plenum 36 which has a first inlet opening 20 to the enclosure and a second outlet opening 21 to the atmosphere therein. A moveable member 32 is driven by hydraulic piston 34 and operates to ensure that only one of the openings to the atmosphere or to the enclosure is operative at any one time. Similarly, plenum 36 located at the other end also has a moveable member 38 and a hydraulic piston 40 for driving member 38 and sealing off one of inlet 23 or outlet 25.

A housing 44 defines an air passageway between plenums 30, 36 and mounted in air passageway are turbines 46. In the illustrated embodiment, there is illustrated two such turbines with the understanding that any suitable number may be provided. Associated with turbines 46 are generators 48 mounted on supports 50 for generating electrical power from turbine 46.

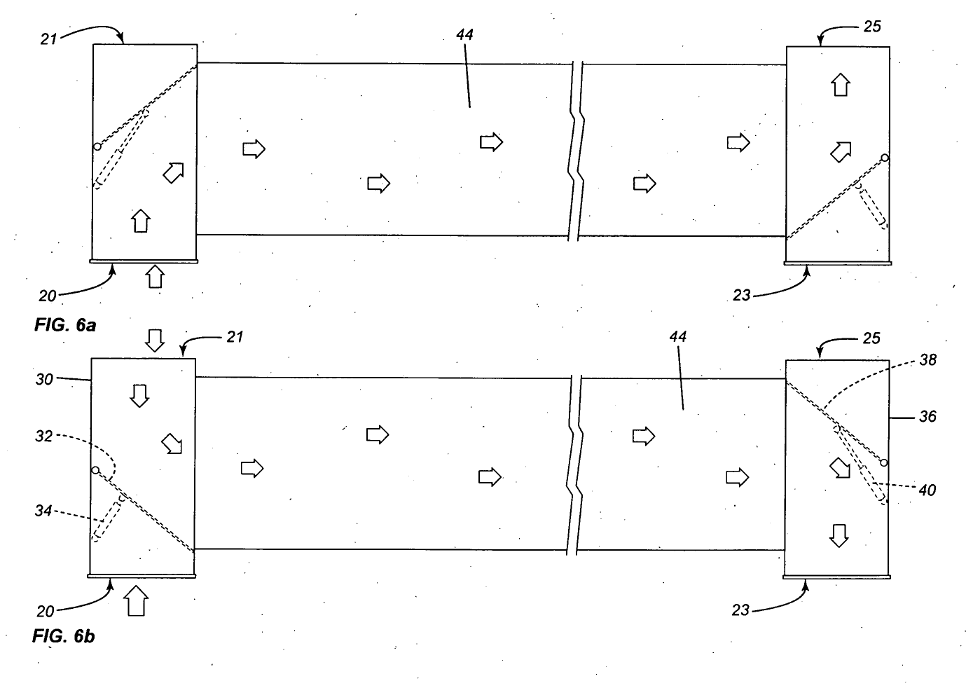

In operation, and as shown in FIG. 6A, during a rising tide, air will be forced from the enclosure into plenum 30 where it will pass through air passageway 44 and turbines 46 before exiting through plenum 36.

As shown in FIG. 6B, during a falling tide, the moveable members 32 and 38 switch positions such that air flowing into the enclosure will enter the top of plenum 30, pass through air passageway 44 and turbines 46 before entering the enclosure via plenum 36.

As will be seen from the above, power is generated both from a rising tide and a falling tide.

It will be understood that the above described embodiments are for purposes of illustration only and that changes and modifications may be made thereto without departing from the spirit and scope of the invention.

I claim:

1. An apparatus for generating energy from rising and falling tides, said apparatus comprising:
a housing having a top wall and a side wall to thereby define an enclosure;
at least one opening to said enclosure located proximate a lower portion of said side wall;
at least one air passageway having first and second ends located at an upper end of said enclosure; each of said ends having an inlet to said enclosure and an outlet to the atmosphere;
a turbine mounted in said air passageway;
a generator operatively associated with said turbine; and
a moveable member located at each of said first and second ends to close one of said inlet and said outlet depending on whether said tide is rising or falling.

2. The apparatus of claim 1 including a first plenum located at a first end of said air passageway, and a second plenum located at a second end of said air passageway, each plenum having one of said moveable members mounted therein.

3. The apparatus of claim 2 wherein said plenums are mounted on top of said housing.

4. The apparatus of claim 2 further including a screening covering said outlet of each of said first and second plenums.

5. The apparatus of claim 2 wherein there are provided a series of openings located proximate a lower portion of said side wall.

6. The apparatus of claim 1 wherein said housing is formed of concrete.

7. The apparatus of claim 5 further including screening about said series of openings to thereby prevent entry of objects into said openings.

8. The apparatus of claim 2 further including a plurality of turbines in said air passageway.

9. A method of generating electricity from rising and falling tides comprising the steps of:
mounting an apparatus in a location having a tidal movement, said apparatus having a top wall, and a side wall to thereby define an enclosure, said apparatus also including at least one air passageway having first and second ends, each of the ends having an inlet to said enclosure and an outlet to the atmosphere, a turbine mounted in said air passageway, a generator operatively associated with said turbine;
permitting water to enter said enclosure proximate the bottom thereof;
passing air displaced from said enclosure to said air passageway to thereby drive the turbine mounted therein, and permitting said air to exit said enclosure;
directing air returning to said enclosure during a falling tide through said air passageway in the same direction as during the rising tide.
